(19) United States
(12) Patent Application Publication
(10) Pub. No.: US 2003/0228559 A1
(43) Pub. Date: Dec. 11, 2003

(54) Device and method for simplifying and stimulating the processes of reading and writing

(76) Inventors: Paul G. Hajjar, Harrisburg, PA (US); Victor J. Hajjar, Harrisburg, PA (US)

Correspondence Address: MARY HOWARD POWELL, ESQ, POWELL & POWELL, P.C., 4701 GREAT OAK LANE, HARRISBURG, PA, 17110, US

(21) Appl. No.: 10/166,870

(22) Filed: Jun. 11, 2002

(51) Int. Cl. G09B 5/00

(52) U.S. Cl. 434/169; 434/156; 434/178

(57) ABSTRACT

This invention relates to a device to assist a person reading printed text and writing text and, more specifically, to such a device which simplifies and stimulates interest in reading and writing, and methods of use thereof. In an embodiment of this invention, a transparent medium has a plurality of parallel lanes placed thereon. Coloring is placed along the lanes. In another embodiment, there is a lane generator, and a tint generator produces a tinted coloring wherein a printed text located within the lanes is displayed on an electronic medium. Visual perception of the lanes having the coloring aids to simplify and stimulate reading and writing.

### BACKGROUND OF THE INVENTION

1. Technical Field of the Invention

This invention pertains to a reading device that assists a person reading printed text and, more specifically, to such a device which simplifies and stimulates interest in reading and writing, and methods of use therefor. This invention describes a relatively transparent medium having a plurality of lanes with coloring positioned thereon for providing alignment to printed text.

2. Background

In the United States of America, of current, illiteracy continues to be a primary concern at the school district, state and national levels. A simple and convenient method for reducing illiteracy is to encourage individuals to read and write frequently and extensively. It is a challenge, however, to effectively encourage reading among individuals who have difficulty following a printed text or who find reading extensive printed text to be a boring task. Beyond social and economic issues associated with illiteracy, during the last three decades, educators have become increasing aware of other contributors to poor reading skills. Initiatives to reduce illiteracy in America are unlikely to net positive results when what should be an enjoyable experience is in fact tedious, strenuous and requires a disproportionate amount of time and concentration.

Normal-sighted people, who have little difficulty reading, take the skills required for reading for granted. Many adult readers have some of the same concerns as students who are children. A large portion of the population experiences difficulty concentrating while reading. This includes children who are learning to read, elderly people who have lost bits of the skill required for serious concentration and other people who need to read slowly for various reasons.

Also, there are good readers who are discouraged when challenged with the task of extensive reading. Graduate and other professional students, librarians and other researchers are often required to read large volumes of small print text in a relatively short period of time. It is not uncommon for such readers to experience mental and physical exhaustion while reading from a hard copy or a computer screen.

One solution to the problems of poor reading skills and the task of reading extensive printed text is to encourage readers to use their fingers to guide them through printed text. This occurs very frequently among readers while providing only limited levels of satisfaction. The flow of reading and comprehension is disrupted by the requirement that the reader's attention be divided and somewhat focused on proper movement of the fingers.

It is also known in the art to place a light source or light colored source behind a dark colored printed text to enhance visibility and stimulate interest in the process of reading. The effectiveness of such a technique dependents on the transparency of the surface on which the text is printed. Where the text is not printed on a transparent material, effective use of such art requires electrical or battery-operated light sources, or light of a specified frequency range, such as ultraviolet light. These light sources, in combination with handling the printed text, are cumbersome and awkward, and may tire the eyes relatively quickly.

As an alternative, the impact of color on printed text is well known and some text is printed in colors other than black. For hard copy printed text, colored print is not always a viable alternative because of the cost differential in black ink and other colors of ink. Compared to black ink, other colors of ink tend not to be as lasting. Black ink is generally less expensive in the print industry. Further, certain authors and publishers prefer black ink.

Another means of encouraging literacy through reading and writing is the use of tinted sheets. There is evidence that tinted transparent sheets placed over printed text is helpful for certain individuals with certain optical dysfunctions. Tinted sheets alone, however, stop short of addressing the concerns of a broader population of readers who may be assisted by a device that helps in aligning the printed text. The presence of aligned color enhances optical properties, visual appearance and mental stimulation.

The use of colored paper is known in the art. Solid colored paper and lined colored paper are available. Of the two types of colored paper currently available, i.e., solid and lined, neither satisfies the eye/brain need to experience an adequate amount of “white” space. When the device of the present invention is used for assisting in reading, any white on the printed text appears through the transparency. When the present invention is used for assisting in writing text, any white on the text surface contributes to the writer's desire for “white” space.

Highlighting markers and pens are known. The use of highlighters is time consuming, relatively permanent and disappointing if the wrong text is highlighted. A primary function of highlighting is to assist with reviewing text that a person has previously read. By contrast, the present invention is non-permanent highlighting available for a person's first reading of a printed text.

The art is familiar with a limited type of electronic lane generators for the purpose of highlighting text. It is known to use abutting lanes in order to highlight for various purposes. It is not known, however, to highlight, in a non-abutting fashion, with coloring while maintaining “white space”.

Effective reading and writing devices for children intended for large-scale use have criteria. Such study devices are often used in classrooms where teachers attempt to teach twenty or more students simultaneously. Therefore, it is highly desirable that the device is simple in structure and simple to use. Also, a reading and writing device used on a regular basis is most effective if it is inexpensive and resilient. Such simplification reduces: the human hours required to teach reading or writing, and the cost of production. Moreover, students seem best aided when an educational device is conveniently portable. A child with reading or writing homework receives limited or no assistance with homework from a device that can not be brought home from school because the device is awkward in size, weight, number of parts, necessitates a teacher's direct instruction or is too valuable to be removed from the school.

While the universe of reading and writing aid devices is plentiful, the art does not reveal the reading and writing aid device of the present invention.

U.S. Pat. No. 838,840, Educational Device, issued Dec. 18, 1906, to George W. Chapman, is a slotted device with rollers for aiding the process of reading. U.S. Pat. No. 4,770,635, Portable Viewer, issued Sep. 13, 1988, to Howard J. Gabay, provides for a viewing slot with a tinted lens. In both patents, '840 and '635, a viewing slot serves the purpose of limiting the amount of text that is viewable in order to assist a reader in focusing on the limited image visible through the viewing slot. Unlike the device of the present invention, the art of '840 and '635 is physically cumbersome and restricts rather than expands the reader's focus.

There are various reading device for persons with dyslexia. U.S. Pat. No. 4,979,902, Dyslexia Reading Device, issued Dec. 25, 1990, to Alix Morelle, et al. discloses a dyslexia reading device for restricting the field of vision. This art relates to eyewear appropriate for person afflicted with the perceptual problem of dyslexia. Unlike the device of the present invention, the art of '902 has neither the element of colored lanes nor lanes. U.S. Pat. No. 4,379,699, Method of and Means for Improved Reading Efficiency of Persons with Specific Dyslexia, issued Apr. 12, 1983, to Eileen M. Nelson provides for a method of preparing reading material. Reading material is printed on a first line and the same reading material is printed on a second line. The first line of reading material has coloring that is substantially contrasting between the printed text coloring and the text background coloring, and the second line of reading material has the opposite contrast from the contrast in the first line of printed text. Unlike the present invention, the disclosure of '699 provides for the production of therapeutic reading material. The present invention provides a device to aid in reading standard commercial reading material. Moreover, the present invention, if helpful to persons experiencing dyslexia, is helpful to readers beyond the worthy intent of '902 and '699.

U.S. Pat. No. 5,145,376, Teaching Aid for Foreign Language, issued Sep. 8, 1992, to Jennifer M. Krass teaches a media imprinted with text of certain colors such that a filtering tinted means utilizing reflected electromagnetic radiation enables a reader to view desired text. Contrary to '376, the device of the present invention does not rely upon electromagnetic radiation.

U.S. Pat. No. 5,163,748, Illuminated Clipboard, issued Nov. 17, 1992, to David L. Messinger discloses a transparent board having a chamber and an illuminating means positioned within the chamber. Unlike the device of the present invention, the device of '748 requires a power source.

U.S. Pat. No. 5,338,201, Method for Teaching Reading Using Hand-Held Reading Guide, issued Aug. 16, 1994, to Shriley S. Levine and U.S. Pat. No. 5,591,033, Apparatus for Efficient Reading, issued Jan. 7, 1997, to Shriley S. Levine both disclose hand-held reading directors. Unlike the present invention, the devices of '201 and '033 provide limited reading assistance utility for a person who is not able to steady the reading directors or is in a motion environment.

U.S. Pat. No. 4,262,432, Study Device, issued Apr. 21, 1981, to Fukuji Hachimura has at least the elements of a casing, a plurality of push-plates, indication plates, an operating mechanism, shafts and a support member. Unlike the present invention, the disclosure of '432 has numerous elements. The number of elements may impact the cost of production and the durability of the device.

### SUMMARY OF THE INVENTION

Therefore, there is a need for a simplified device that stimulates interest in reading and writing. The present invention provides a reading and writing device having a simplified structure which overcomes the foregoing problems attendant conventional reading and writing aid devices. The present invention is a device and method for simplifying and stimulating reading and writing by forcing the eye to concentrate on a specific location while not interrupting or restricting the reading pace. The device may be placed over a printed text for assisting in read or placed under a writing surface for assisting in guiding a writer. The present invention acts as a concentrator to force the eye to follow specific text to be read. For example, the use of coloring along a plurality of lanes on a medium simplifies the task of concentration. In application, a reader focused on the printed text of a particular lane with coloring, e.g., green, is better able to ignore other text yet is at liberty to establish a preferred reading pace. The medium, with lanes of coloring, aids the eye to rapidly move through the printed text. The present invention also acts as a concentrator to encourage a writer's hand, via eye-hand coordination, to follow a specific lane along a writing surface.

Accordingly, one advantage of the invention is to provide a means for simplifying and stimulating the processes of reading and writing.

It is an advantage of the invention to provide a means for the beginning reader to remain focused on the material and subject matter to be read.

It is a desire of the present invention is to provide a means for the beginning student to improve his or her writing.

An additional feature of the present invention is to assist in reading and writing horizontal and vertical text, including numerical data.

### BRIEF DESCRIPTION OF THE DRAWINGS

FIG. 1 is a perspective view of the present invention wherein a transparent medium is produced, a plurality of lanes is positioned thereon and coloring has been applied to the lanes.

FIG. 2 is a front elevation depiction of the instant invention wherein a plurality of lanes is positioned on a transparent medium and coloring has been applied to the lanes.

FIG. 3 illustrates examples of linear-arranged designs that may compose the lanes.

FIG. 4 depicts a medium having tint throughout.

FIG. 5a is a plan view depiction of the topside of the present invention wherein there are lanes and coloring within the lanes.

FIG. 5b is a plan view depiction of the bottom side of the embodiment of the present invention in FIG. 5a. In FIG. 5b, there are lanes and coloring within the lanes and the coloring is different from the lane coloring in FIG. 5a.

FIG. 6 depicts a perspective view wherein the device of the present invention is layered over printed text for simplifying and stimulating the process of reading and the medium has magnifying optical capacity.

FIG. 7 is a perspective view of a medium of the present invention layered over vertical printed text, wherein the lanes on the medium are randomly spaced and of random length and random width and having staggering breaks.

FIG. 8 is a perspective drawing of the present invention layered under a writing surface for simplifying and stimulating the process of writing.

FIG. 9 illustrates the present invention attached to a computer monitor to assist in reading text displayed on the computer monitor, wherein the attachment means is static cling.

FIG. 10a is a block diagram showing an electronic embodiment of the present invention.

FIG. 10b is a block diagram showing an electronic embodiment of the present invention.

FIG. 10c illustrates an electronic medium for displaying lanes having coloring.

### DETAILED DESCRIPTION OF THE INVENTION

The present invention is a device 10 and method for simplifying and stimulating the processes of reading and writing. When in service, the device 10 may be appropriately positioned to assist with horizontal and vertical text. Although this invention is shown and described with respect to the detailed embodiments thereof, it will be appreciated and understood by those skilled in the art that various changes in form and detail thereof may be made without departing from the spirit and scope of the claimed invention.

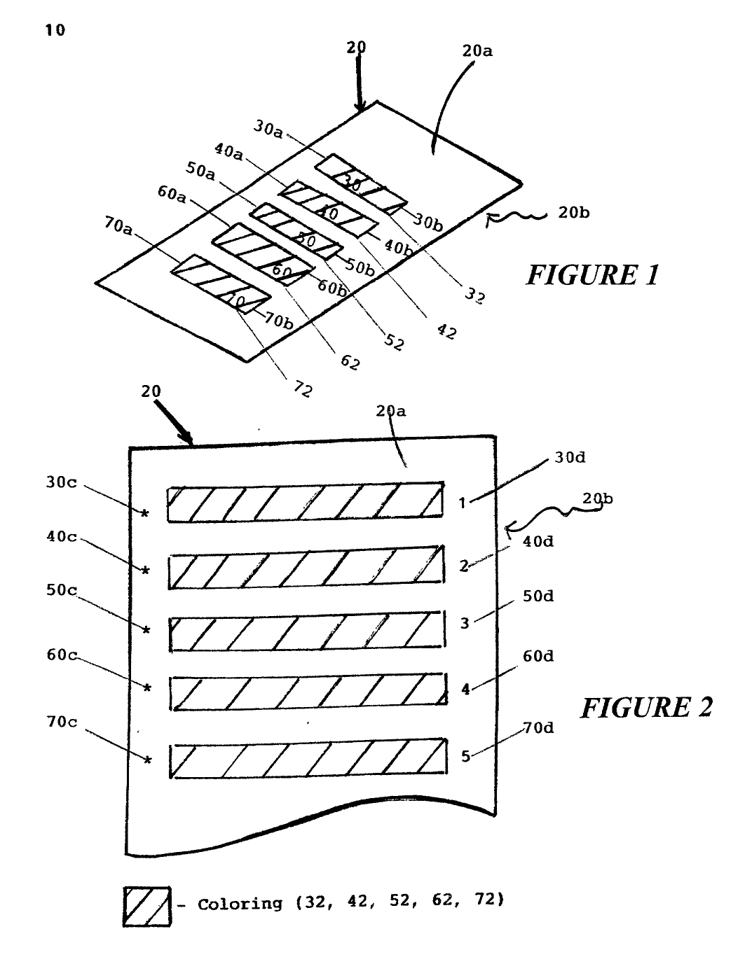

In an embodiment of the invention as disclosed in FIG. 1 and FIG. 2 of the drawings, a relatively flat and planar transparent medium 20, having a topside 20a and a bottom side 20b, is made of a flexible, resilient transparent plastic, the transparency permitting visibility of a printed text therethrough when the medium is layered on top of a text surface where printed text is located. The medium 20 may be made of various materials possessing the property of transparency or translucency, including, while not limited to, glass, vinyl, acrylic resin or polymeric resin. The medium 20 in most applications is sized not larger than a DIN size A4 sheet in order to conveniently fit over a standard text surface such as a magazine, college textbook or computer monitor screen.

FIG. 1 further depicts a plurality of lanes 30, 40, 50, 60,70 for positioning on the transparent medium 20 to serve to direct eye movement. Each of the lanes 30, 40, 50, 60, 70 is parallel one to another and extends from a respective beginning edge 30a, 40a, 50a, 60a, 70a to a respective ending edge 30b, 40b, 50b, 60b, 70b. In FIG. 2, a marker 30c, 40c, 50c, 60c, 70c, 30d, 40d, 50d, 60d, 70d is located in proximity to each of the edges 30a, 40a, 50a, 60a, 70a, 30b, 40b, 50b, 60b, 70b, respectively. The markers 30c, 40c, 50c, 60c, 70c, 30d, 40d, 50d, 60d, 70d assist a reader to focus on, and not lose, a particular place in the printed text. The markers 30c, 40c, 50c, 60c, 70c, 30d, 40d, 50d, 60d, 70d may be alphanumeric, symbols, indicia or pictorial.

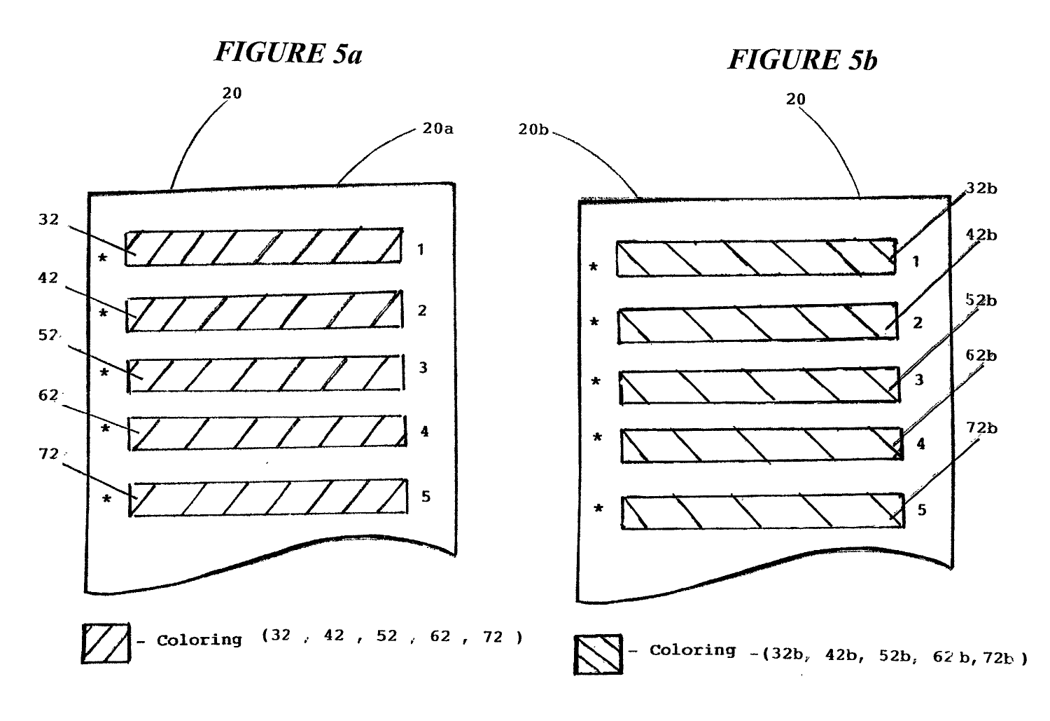

In FIG. 1 and FIG. 2, a coloring 32, 42, 52, 62, 72 is positioned along the lanes 30, 40, 50, 60, 70 of the topside 20a of the medium 20 and is sufficiently clear to permit visibility of the printed text and to assist the reader by guiding the reader's eye along any printed text or a writer's writing surface. In FIG. 1, the coloring 32, 42, 52, 62, 72 is a brilliant transparent color positioned within the lanes 30, 40, 50, 60, 70 in order to create contrast, and enhance the reading or writing experience, while not obstructing visibility therethrough. The coloring 32, 42, 52, 62, 72 may be any color with sufficient clarity. The coloring 32, 42, 52, 62, 72 may be selected from, while not limited to, brilliant, pastel, primary, gray or florescent, and there may be more than one color to compose the coloring 32, 42, 52, 62, 72 on the medium 20. For example, the coloring 32 on a particular lane 30 may vary from the coloring 42 on another lane 40. Also, as depicted at FIG. 5b, there is a transparent coloring 32b, 42b, 52b, 62b, 72b positioned on the bottom side 20b of the medium 20 that is different from the topside 20a coloring 32, 42, 52, 62, 72 at FIG. 5a. This difference in coloring enhances the utility of the device. Different readers are sometimes stimulated differently by various colors, and a particular reader or writer may desire to work with different colors at different times.

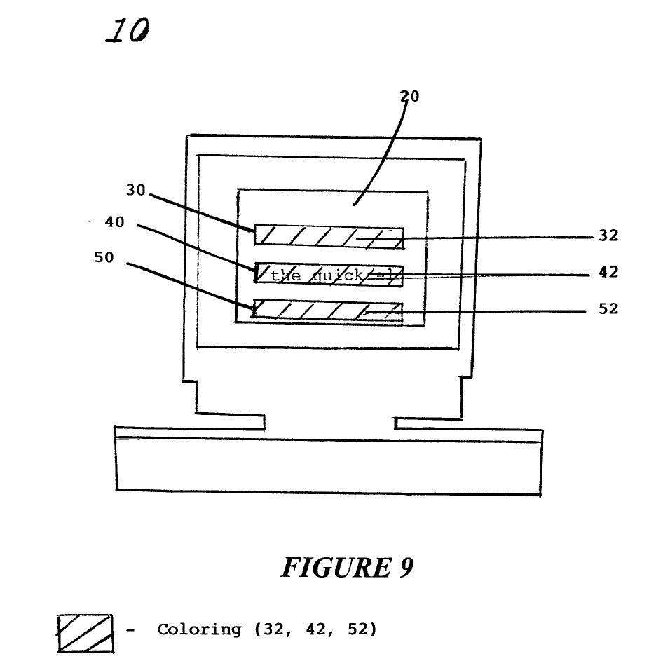

According to FIG. 1 further, the lanes 30, 40, 50, 60, 70 each have a width of approximately 1.0 centimeter to 2.0 centimeters and are equally spaced. The spatial separation and the brilliant coloring 32, 42, 52, 62, 72 along the lanes 30, 40, 50, 60, 70 have the effect of “highlighting” numerous lines of printed text where the font size of the printed text is typical for a textbook or magazine. The transparent medium 20 has a non-shiny finish on the topside 20a to minimize glare. Further, the transparent medium 20 possesses the attachment mechanism 110 of sufficient static cling to facilitate temporary adherence to pages in a textbook or the screen of a computer monitor, according to FIG. 9, when the medium 20 is positioned adjacent to and generally coplanar with the computer monitor screen.

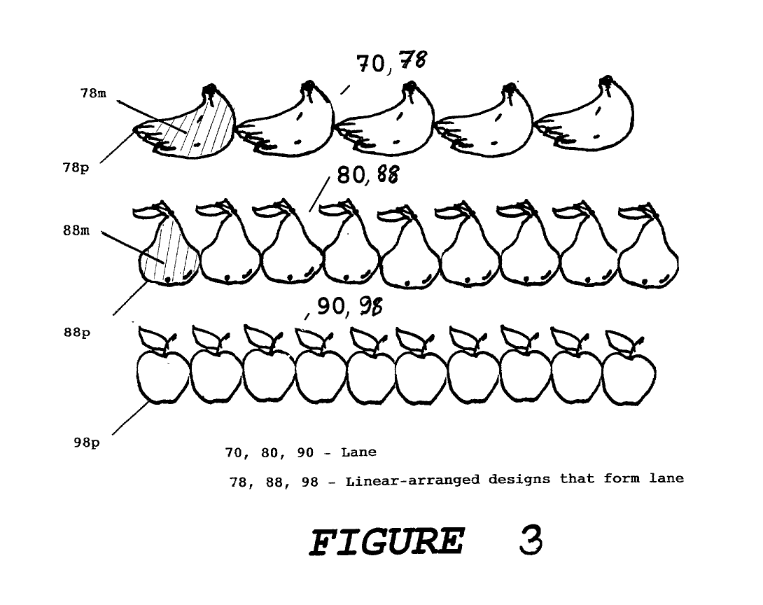

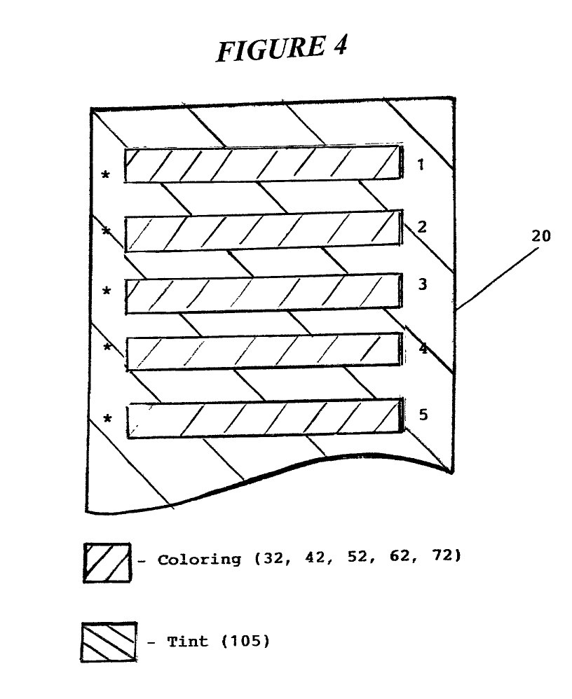

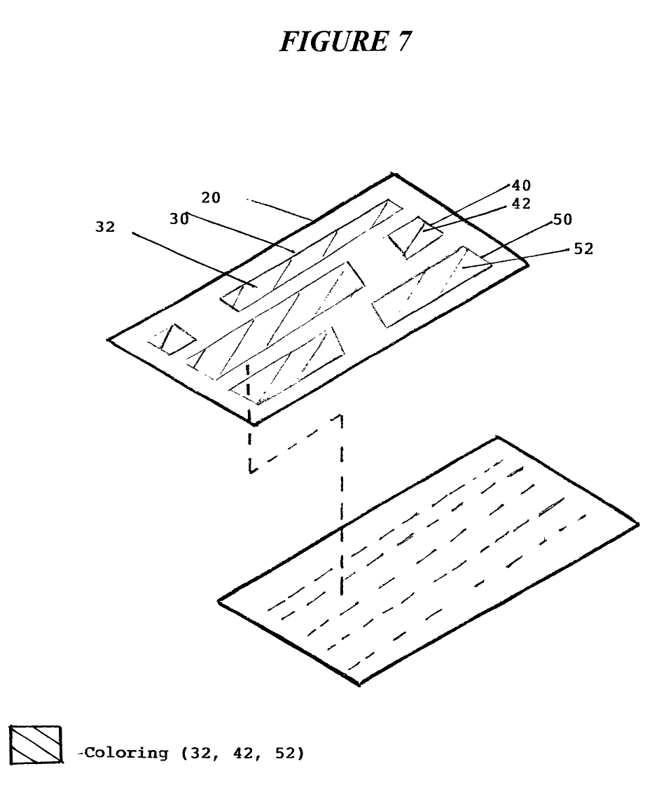

The lanes, for example 30, 40, 50, 60, 70, on the medium 20 are variable. For the sake of brevity and simplicity, the drawings in FIG. 2, FIG. 4, FIG. 5a and FIG. 5b are truncated to show only a small number of lanes 30, 40, 50, 60, 70. Also, in FIG. 7, the width of each of the lanes 30, 40, 50, as well as the length, spacing and staggering breaks in the lanes 30, 40, 50, respective of each other, are variable. In FIG. 3, the lanes 70, 80, 90 are composed of linear-arranged designs. The linear-arranged design 70, 80, 90 may be selected from opotypes, letters, figures, symbols, indicia or images.

In the embodiment shown in FIG. 4, in addition to the coloring 32, 42, 52, 62, 72 of the lanes 30, 40, 50, 60, 70, the medium 20 has a tint 105 throughout. This continuous tint 105 positioned on the medium 20, in combination with the coloring 32, 42, 52, 62, 72 of the lanes 30, 40, 50, 60, 70, provides further stimulation for the reader, thus hastening optical movement and maintaining mental stimulation in the printed text.

FIG. 3 demonstrates the lanes 70, 80, 90 as composed of a linear-arranged design 78, 88, 98. The linear-arranged design 78, 88, 98 or combination of designs includes optotypes, letters, figures, symbols, indicia and images. Any coloring at the interior 78m, 88m, 98m or the outline 78p, 88p, 98p of the linear-arranged design 78, 88, 98 may serve to constitute the coloring 72, 82, 92 for the lanes 70, 80, 90.

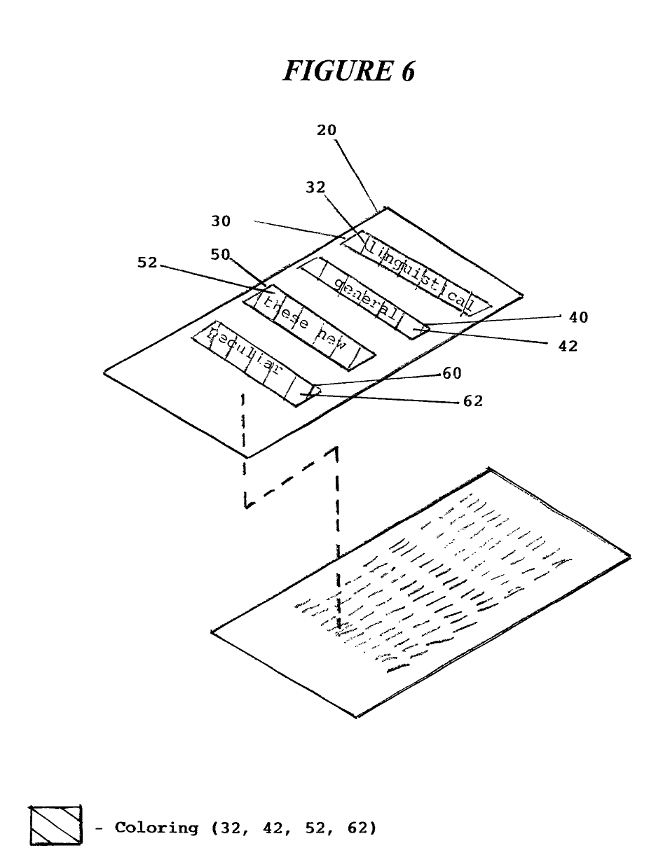

FIG. 6 depicts an embodiment of the present invention wherein the medium 10 is layered over printed text and the medium 20 has magnifying optical capacity.

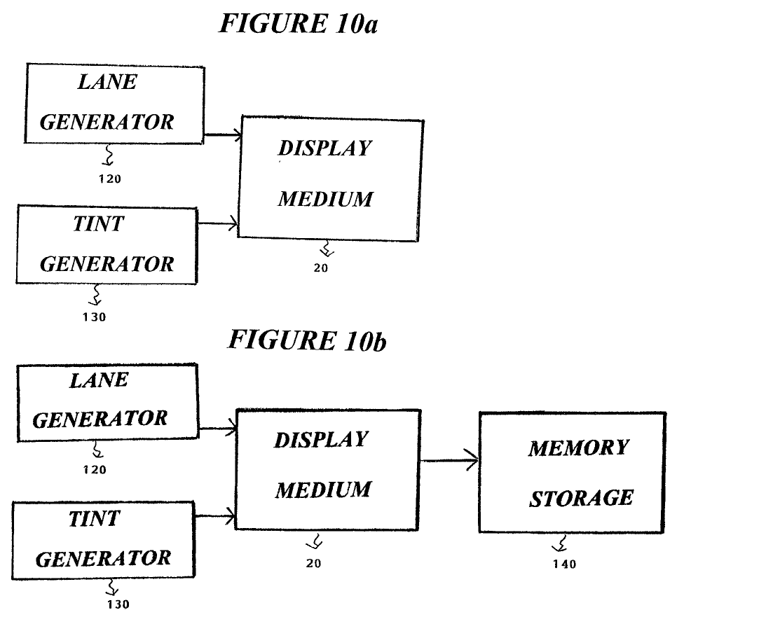

FIG. 10a is a basic arrangement of the device 10. The embodiment at FIG. 10a is an electronic device 10, wherein there is a medium 20 for displaying printed text. A lane generator 120 is designated for generating lanes along the printed text. Lanes 30, 40, 50 depicted in FIG. 10c are separated when generated such that the lanes 30, 40, 50 do not abut each other and some “white space” is generally maintained on the text surface. A tint generator 130 is designated for producing a tinted coloring 32, 42, 52 wherein printed text located within lanes 30, 40, 50 is visible. FIG. 10b shows the electronic device 10 having the ability of memory storage 140 in order to recall printed text upon which tinted coloring 32, 42, 52 has been previously generated. Lanes 30, 40, 50 of various length and width as illustrated in FIG. 7 may simultaneously offer coloring 32, 42, 52. In FIG. 10c, the electronic medium 20 may simultaneously offer coloring 32, 42, 52.

There are at least several methods of using the present invention. FIG. 6 and FIG. 9, by way of examples, refer to methods of using the device 10 which include the steps of placing the medium 20 in a position between the reader and the printed text. The attachment means 110 is static cling. The printed text is visible through the medium 20. The reader's eye views the printed material through the medium 20 as the eye flows from one place in the printed text to the directed next place in the printed text with the assistance of the lanes 30, 40, 50 that direct with the coloring 32, 42, 52 in a free flowing, uninterrupted fashion. At FIG. 5a and FIG. 5b, should the reader desire, by shifting the position of the medium 20, the reader is able to alter the alignment of the topside 20a of the medium 20, or flip the medium 20 to the bottom side 20b, and select a lane 30, 40, 50, 60, 70 with the coloring 32b, 42b, 52b, 62b, 72b that appeals to the reader. FIG. 10c refers to a method of using the device 10 of the present invention by displaying the printed text on an electronic medium 20 and displaying the lanes 30, 40, 50 with coloring 32, 42, 52 on the printed text wherein the coloring 32, 42, 52 permits visibility of the printed text.

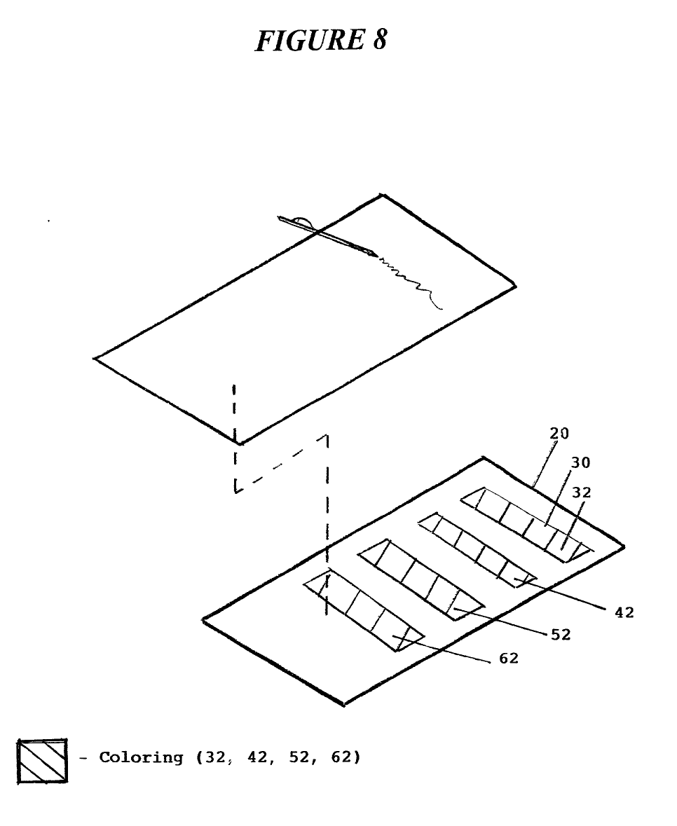

At FIG. 8, to assist in stimulating writing, the medium 20 may be placed in a position under an appropriate writing surface. The coloring 32, 42, 52, 62, 72 visible through the writing surface provides stimulation as the writer writes onto the surface. By shifting the position of the medium 20, the writer is able to alter the alignment of the medium 20 and hence the alignment of the written material.

While the present invention has been shown in various embodiments, it is apparent to those skilled in the art of the various modifications that can be made without departing from the spirit or scope of the invention as encompassed by the following claims.

We claim:

1. A device for simplifying and stimulating the processes of reading from a text surface and writing onto a text surface, comprising:
a medium having sufficient clarity to permit visibility therethrough and the medium having a topside and a bottom side;
a plurality of lanes for placement on said medium to direct eye movement for reading and writing, each of said lanes having a beginning edge and extending to an opposing ending edge, respectively; and
a coloring positioned on said medium along said lanes such that said coloring having sufficient clarity to permit visibility of a printed text on a text surface and assisting a reader by guiding the reader's eye along the printed text.

2. The device for simplifying and stimulating the processes of reading and writing as set forth in claim 1, wherein said medium is transparent.

3. The device for simplifying and stimulating the processes of reading and writing as set forth in claim 1, wherein said medium is translucent.

4. The device for simplifying and stimulating the processes of reading and writing as set forth in claim 1, wherein said medium is made of a material selected from the group consisting of glass, vinyl, acrylic resin and polymeric resin.

5. The device for simplifying and stimulating the processes of reading and writing as set forth in claim 1, wherein said medium is made of plastic having flexibility and resilience.

6. The device for simplifying and stimulating the processes of reading and writing as set forth in claim 1, wherein said medium is flat and planar.

7. The device for simplifying and stimulating the processes of reading and writing as set forth in claim 1, wherein at least said topside of said medium has a non-shiny finish.

8. The device for simplifying and stimulating the processes of reading and writing as set forth in claim 1, wherein said lanes are parallel one to another.

9. The device for simplifying and stimulating the processes of reading and writing as set forth in claim 1, wherein said lanes are randomly spaced and are of random length and random width and have staggering breaks.

10. The device for simplifying and stimulating the processes of reading and writing as set forth in claim 1, wherein said coloring is selected from the group consisting of pastel, primary, gray, brilliant and florescent.

11. The device for simplifying and stimulating the processes of reading and writing as set forth in claim 1, wherein there is a pale tint throughout said medium.

12. The device for simplifying and stimulating the processes of reading and writing as set forth in claim 1, wherein said medium has magnifying optical capability.

13. The device for simplifying and stimulating the processes of reading and writing as set forth in claim 1, wherein said coloring in said lanes is not the same color in all said lanes such that said coloring varies in color from lane to lane.

14. The device for simplifying and stimulating the processes of reading and writing as set forth in claim 1, wherein said coloring in said lanes on said topside of said medium is a color different from said coloring of a color on said bottom side of said medium such that a plurality of colors may be used for said coloring.

15. The device for simplifying and stimulating the processes of reading and writing as set forth in claim 1, wherein said lanes are composed of at least one linear-arranged design.

16. The device for simplifying and stimulating the processes of reading and writing as set forth in claim 1, wherein said lanes are composed of at least one linear-arranged design from the group consisting of optotypes, letters, figures, symbols, indicia and images.

17. The device for simplifying and stimulating the processes of reading and writing as set forth in claim 1, wherein said lanes are identified on at least one of said respective edges with at least one marker selected from the group consisting of alphanumeric, symbols, indicia and pictorial.

18. The device for simplifying and stimulating the processes of reading and writing as set forth in claim 1, wherein each said lane is approximately 1.0 centimeter to 5.0 centimeters wide.

19. The device for simplifying and stimulating the processes of reading and writing as set forth in claim 1, further comprising an attachment mechanism for coupling said medium to the text surface displaying the printed text.

20. The device for simplifying and stimulating the processes of reading and writing as set forth in claim 1, further comprising an attachment mechanism composed of sufficient static cling to facilitate temporary adherence to the text surface.

21. The device for simplifying and stimulating the processes of reading and writing as set forth in claim 1, wherein said medium is sized less than or equivalent to a standard DIN A4 page and said lanes have separation of approximately 2.0 centimeters.

22. A device for electronically simplifying and stimulating reading and writing, comprising:
(a) an electronic medium for displaying printed text;
(b) a lane generator for generating lanes spaced apart such that generated lanes do not abut; and
(c) a tint generator for producing a tinted coloring wherein a printed text located within said lanes is visible.

23. The device set forth in claim 22, wherein a cluster of printed text is colored by said lanes for the purposes of simplifying and stimulating reading and writing.

24. The device for simplifying and stimulating the process of reading and writing as set forth in claim 22, wherein said tint generator tints the printed text as the printed text is printed.

25. The device for simplifying and stimulating the process of reading and writing as set forth in claim 22, further comprising a memory storage such that the printed text colored by said tint generator remains colored until said coloring is removed by the reader.

26. A method for using a device for simplifying and stimulating the processes of reading and writing, comprising the steps of:
(a) positioning a medium between a reader and a text surface having printed text placed thereon, said medium having sufficient clarity to permit visibility therethrough and a plurality of transparent colored lanes placed thereon;
(b) viewing the printed text through said medium; and
(c) shifting said positioning of said medium to achieve alignment.

27. A method for using a device for simplifying and stimulating the processes of writing, comprising the steps of:
(a) illuminating a writing surface by placing a medium in a position under the writing surface, said medium having sufficient clarity to permit visibility therethrough and a plurality of colored lanes placed thereon;
(b) writing onto the writing surface; and
(c) shifting the position of said medium to achieve alignment.

28. A method for use of an electronic device for simplifying and stimulating reading, comprising the steps of:
(a) displaying a printed text on a electronic device, and
(b) displaying colored lanes on printed text such that said colored lanes are of sufficient clarity to permit visibility of the printed text.
